(19) United States
(12) Patent Application Publication
(10) Pub. No.: US 2012/0091239 A1
(43) Pub. Date: Apr. 19, 2012

(54) Feed Shaft for Feeding Particulate Material to a Mill

(75) Inventors: Luis Petersen, Valby (DK); Lars Witt, Copenhagen (DK)

(73) Assignee: FLSMIDTH A/S, Valby (DK)

(21) Appl. No.: 13/259,730

(22) PCT Filed: Mar. 24, 2010
(86) PCT No.: PCT/IB2010/051294

§ 371 Date: Sep. 23, 2011

(30) Foreign Application Priority Data
Mar. 27, 2009 (DK) PA 2009 00421

(51) Int. Cl. B02C 15/00

(52) U.S. Cl. 241/109

(57) ABSTRACT

A description is given of an inclined feed shaft for feeding particulate material to a mill. The feed shaft is configured for rotation about its longitudinal axis. The feed shaft may be configured so that any incipient formation of coatings on a wall of the shaft is continuously cleaned off and dislodged from that wall by descending material particles in the feed material so that the feed shaft is self cleaning.

### CROSS REFERENCE TO RELATED APPLICATIONS

This application is the United States national stage under 35 U.S.C. §371 of International Application No. PCT/IB2010/051294, filed on Mar. 24, 2010, which claimed priority to Danish Patent Application No. PA 2009 00421, filed on Mar. 27, 2009. The entirety of these applications is incorporated by reference herein.

### FIELD OF THE INVENTION

The present invention relates to an inclined feed shaft for feeding particulate material to a mill.

### BACKGROUND OF THE INVENTION

A feed shaft of the aforementioned kind is generally known as may be appreciated from the United Kingdom Patent No. GB 2214106. For example, in the cement manufacturing industry a feed shaft of said kind is used to feed material to be ground to a mill, such as a vertical mill, a hammer crusher, a drier crusher or similar devices. In cases where the material to be ground comprises hydraulic materials, such as blast-furnace slag, cement clinker or similar materials, and where a moist environment occurs in the mill, this will quite often result in clogging of the feed shaft. This is due to the fact that particularly the finest particles in the material feed will adhere to and set on the wall of the shaft, causing substantial coatings to be formed, eventually obstructing the shaft completely. Inspections of feed shafts have revealed that such coatings are initially formed at the sides of the cross-sectional profile of the shaft, and that to a substantial degree the bottom is kept clear by the descending feed material. Up until now, such coatings have been removed or attempts to remove them have been made by injecting high-pressure air through nozzles in the shaft wall. In addition to being a quite expensive method, the method has also proved to be insufficient to keep the shaft as clean as desirable.

### SUMMARY OF THE INVENTION

It is the objective of the present invention to provide a feed shaft for feeding particulate material to a mill whereby the aforementioned disadvantages are eliminated.

This is obtained by means of a feed shaft of the kind mentioned in the introduction and being characterized in that it is configured for rotation about its longitudinal axis.

It is hereby obtained that any incipient formation of coatings on the wall of the shaft will continuously be cleaned off and dislodged from the wall by the larger descending particles of material in the feed material so that the feed shaft will be of a self-cleaning type. This is due to the fact that during the rotation of the shaft the entire circumference of the shaft will intermittently be located at the bottom of the cross-sectional profile of the shaft, and thereby be cleaned off by the descending material. As a result, coatings continuously being formed during the rotation of the shaft on those parts of the shaft wall not located at the bottom will continuously be cleaned off when these parts pass the bottom of the cross-sectional profile of the shaft.

In order to minimize any tendency towards formation of coatings in the shaft, it is preferred that the shaft is formed as a circular-cylindrical duct, preferentially with an inner side having the highest possible degree of smoothness.

Because of the self-cleaning effect which is achieved by rotating the feed shaft, the feed shaft can be positioned at a smaller inclination relative to the horizontal level than has previously been attainable, typically with an inclination between 50 and 60 degrees. This means that at a given length of the feed shaft it will be possible to feed material to a location deeper inside the mill. The feed shaft according to the invention may be positioned at an angle relative to the horizontal level of between 20 and 80 degrees, preferably between 30 and 60 degrees.

To prevent excessive coatings from being formed during the rotation of the feed shaft, it is preferred that the feed shaft is configured for rotating at a rotational speed of between 0.1 and 10 revolutions per minute, preferably between 1 and 3 revolutions per minute.

The feed shaft may in principle be configured for rotation by means of any suitable means. The rotation of the shaft may thus be provided by using a ring motor which is mounted around the shaft, for example. However, it is preferred that the means for rotating the shaft comprises a girth gear which is mounted on the shaft and a motorized gear wheel which meshes with the girth gear. Alternatively, the means of rotation may comprise a motorized pulley transferring the driving torque to the feed shaft through fictional forces. As a consequence hereof, small radial movements of the shaft will be permissible.

The feed shaft may be supported in any suitable manner which will permit free rotation of the feed shaft about its longitudinal axis. It is preferred that the feed shaft at its upper end comprises a radially outward protruding flange and being supported here using a radial/axial bearing and that it is supported at its lower end using one or several radial bearings.

In order to reduce the formation of coatings on the inner side of the feed shaft, it has proved to be advantageous if the shaft wall is heated since this will cause evaporation of any inherent moisture in the material adhering to the shaft wall, thereby reducing the tendency of the material to set on the wall. For this reason, the feed shaft according to the invention should preferably be surrounded by a casing over a substantial part of its length which together with the feed shaft defines an annular gap configured for introduction of hot air.

The feed shaft may further be equipped with supplementary means for cleaning the shaft wall. Such means may for example comprise a vibration device causing the feed shaft to vibrate at certain intervals. The vibration device may for example comprise a number of activation projections protruding radially from the feed shaft and being distributed around the circumference of the feed shaft, with said projections impacting a stationary ramp during the rotation of the feed shaft. Alternatively, the vibration device may comprise a rapper mechanism impacting the outer side of the feed shaft at certain intervals.

The supplementary means may further comprise a compressed-air system for injecting compressed air into the feed shaft.

Additionally, the feed shaft may in special cases be equipped with means for introducing water.

Other details, objects, and advantages of the invention will become apparent as the following description of certain present preferred embodiments thereof and certain present preferred methods of practicing the same proceeds.

### BRIEF DESCRIPTION OF THE DRAWINGS

The invention will now be explained in further details with reference to the drawings, being diagrammatical, and where

FIG. 1 is a side view of an embodiment of a feed shaft according to the invention; and

FIG. 2 is a cross sectional view of the embodiment of the feed shaft shown in FIG. 1 taken along section A-A identified in FIG. 1.

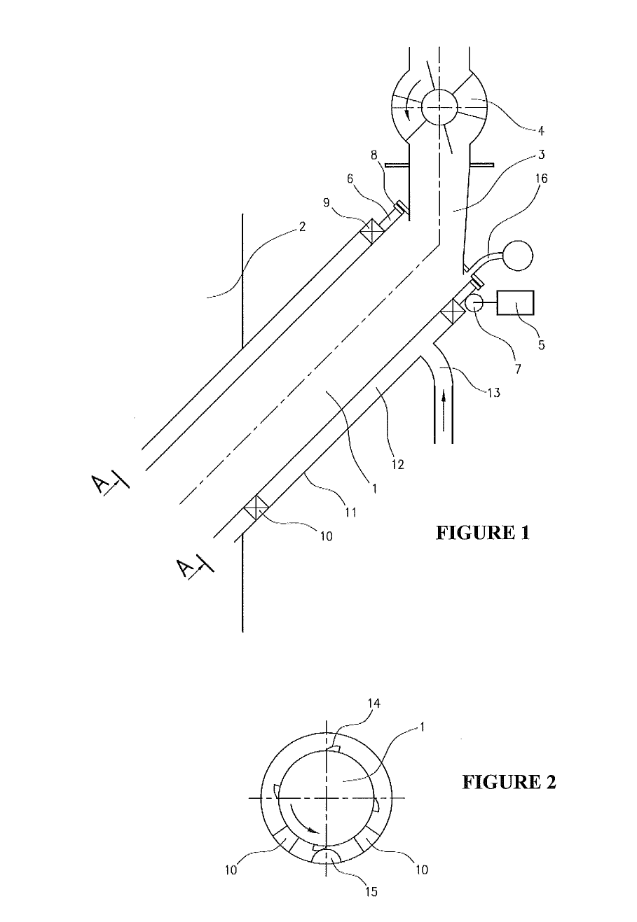

### DETAILED DESCRIPTION OF PRESENT PREFERRED EMBODIMENTS

The figure shows an inclined feed shaft 1 for feeding particulate material to a mill 2 from a feed sluice 4 via a hopper 3.

According to the invention the feed shaft 1 is configured for rotation about its longitudinal axis so that any incipient formation of coatings on the shaft wall will continuously be cleaned off and dislodged from the wall by the larger descending material particles in the feed material.

In the shown embodiment the feed shaft 1 is formed as a circular-cylindrical duct having a smooth inner side in order to minimize the tendency towards formation of coatings.

The feed shaft 1, in the embodiment shown, is positioned at an angle of about 60 degrees relative to horizontal, but because of the self-cleaning effect achieved by the rotation of the feed shaft it can be positioned at a much smaller inclination, as low as approximately 20 degrees relative to horizontal. Hence at a given length of the feed shaft 1 the material can be fed to a location deeper inside the mill 2.

The feed shaft 1 rotates at a rotational speed of between 0.1 and 10 revolutions per minute, preferably between 1 and 3 revolutions per minute to prevent excessive coatings from being formed during the rotation of the feed shaft before they are cleaned off.

The feed shaft 1, in the embodiment shown, is rotated by means of a drive mechanism comprising a girth gear 6 which is mounted on the shaft 1 and a gear wheel 7 which meshes with the girth gear 6 and being driven by a motor 5. The drive mechanism may alternatively comprise a motorized pulley, not shown, to transfer through frictional forces the driving torque to the feed shaft 1.

In the embodiment shown the feed shaft 1 comprises at its upper end a radially outwardly protruding flange 8 and its position is maintained in the radial as well as axial direction by means of an annular radial/axial bearing 9. At its lower end the feed shaft 1 is supported by means of one or more radial bearings 10.

In the shown embodiment the feed shaft 1 is surrounded over a substantial part of its length by a casing 11 which together with the feed shaft 1 defines an annular gap 12 into which hot air can be introduced via an inlet 13. Hence the shaft wall is heated causing evaporation of any moisture inherent in the material adhering to the shaft wall, thereby reducing the formation of coatings on the inner side of the feed shaft.

The feed shaft 1 further comprises a vibration device in the form of a number of activation projections 14 which protrude radially from the feed shaft 1, and being distributed around its circumference, with said projections impacting a stationary ramp 15 during the rotation of the feed shaft.

The feed shaft 1 also comprises a compressed-air system 16 for injecting compressed air into the feed shaft 1.

It should be appreciated that utilization of embodiments of the feed shaft may result in any incipient formation of coatings on the wall of the shaft to be continuously cleaned off and dislodged from the wall by the larger descending material particles in the feed material so that the feed shaft will be of a self-cleaning type. This is due to the fact that during the rotation of the shaft the entire circumference of the shaft will intermittently be located at the bottom of the cross-sectional profile of the shaft, and thereby be cleaned off by the descending material. As a result, coatings continuously being formed during the rotation of the shaft on those parts of the shaft wall not located at the bottom will continuously be cleaned off when these parts pass the bottom of the cross-sectional profile of the shaft.

While certain present preferred embodiments of the feed shaft and certain embodiments of methods of practicing the same have been shown and described, it is to be distinctly understood that the invention is not limited thereto but may be otherwise variously embodied and practiced within the scope of the following claims.

1. An inclined feed shaft for feeding particulate material to a mill, comprising a feed shaft positionable adjacent to a mill to feed material to the mill, the feed shaft configured for rotation about its longitudinal axis.

2. A The feed shaft of claim 1 wherein the feed shaft is a circular-cylindrical duct.

3. The feed shaft of claim 1 wherein the feed shaft has an opening through which the feed material passes through to be fed to the mill, the opening defined by a smooth inner side of the feed shaft.

4. A The feed shaft of claim 1 wherein the feed shaft is positionable at an angle relative to horizontal of between 20 and 80 degrees or degrees, preferably between 30 and 60 degrees.

5. The feed shaft of claim 1 wherein the feed shaft is rotated at a rotational speed of between one of 0.1 and 10 revolutions per minute and 1 and 3 revolutions per minute.

6. The feed shaft of claim 1 further comprising a girth gear mounted on the feed shaft and a motorized gear wheel meshing with the girth gear, the girth Rear and gear wheel driving rotation of the feed shaft.

7. A The feed shaft of claim 1 further comprising a motorized pulley transmitting the driving torque to the feed shaft through frictional forces to drive rotation of the feed shaft.

8. The feed shaft of claim 1 further comprising a radially outwardly protruding flange adjacent an upper end of the feed shaft, the flange being supported by one of a radial bearing and an axial bearing adjacent the upper end of the feed shaft, and wherein a lower end of the feed shaft is supported by at least one radial bearing.

9. The feed shaft of claim 1 further comprising a casing, the casing surrounding at least a substantial portion of a length of the feed shaft, the casing and the feed shaft defining an annular gap sized and configured for hot air to pass through the gap via an inlet in communication with the gap.

10. The feed shaft of claim 1 further comprising a device for cleaning an inner wall of the feed shaft, the device comprising a vibration device that causes the feed shaft to vibrate at certain intervals.

11. The feed shaft of claim 1 further comprising a device for cleaning an inner wall of the feed shaft comprising a compressed-air system for injecting compressed air into the feed shaft.

12. A mill system comprising:
a mill;
an inclined feed shaft having a first end, a second end opposite the first end, a length, a width, and an inner wall defining an opening through which feed material passes for moving through the feed shaft and into the mill;
the feed shaft being positioned adjacent to the mill such that a portion of the feed mill is positioned in the mill and the feed shaft is in an inclined position such that the first end is above the lower end;
the feed shaft being rotatable about a longitudinal axis defined by the length of the feed shaft, rotation of the feed shaft configured to cause feed material to hit other feed material positioned on the inner wall to clean off any feed material that is positioned on the inner wall of the feed shaft.

13. The mill system of claim 12 wherein the mill is vertical mill, a hammer crusher, or a drier crusher.

14. The mill system of claim 12 wherein an angle of inclination of the feed shaft is between 20° and 80° or wherein the angle of inclination of the feed shaft is between 30° and 60°.

15. The mill system of claim 12 wherein the feed shaft is rotated at a rotational speed of between one of 0.1 and 10 revolutions per minute and 1 and 3 revolutions per minute.

16. The milling system of claim 12 further comprising a girth gear mounted on the feed shaft and a motorized gear wheel meshing with the girth gear, the girth gear and gear wheel driving rotation of the feed shaft.

17. The milling system of claim 12 further comprising a motorized pulley transmitting driving torque to the feed shaft through frictional forces to drive rotation of the feed shaft.

18. The milling system of claim 12 wherein the feed shaft also comprises a radially outwardly protruding flange adjacent the first end of the feed shaft, the flange being supported by one of a radial bearing and an axial bearing adjacent the first end of the feed shaft, and wherein the second end of the feed shaft is supported by at least one radial bearing.

19. The milling system of claim 12 further comprising a casing, the casing surrounding at least a portion of the feed shaft, the casing and the feed shaft defining an annular gap sized and configured for hot air to pass through the gap via an inlet in communication with the gap.

20. The milling system of claim 12 further comprising a cleaning apparatus, the cleaning apparatus comprising one of:
a compressed-air system for injecting compressed air into the feed shaft; and
a vibration device that causes the feed shaft to vibrate when actuated.
